(19) United States
(12) Patent Application Publication
(10) Pub. No.: US 2002/0050696 A1
(43) Pub. Date: May 2, 2002

(54) Handlebar unit and footplate mounting arrangement for kick scooter

(76) Inventor: Mey-Chu Lan, San-Chung City (TW)

Correspondence Address: Keith Kline, PRO-TECHTOR INTERNATIONAL SERVICES, 20775 Norada Court, Saratoga, CA, 95070-3018, US

(21) Appl. No.: 09/753,949

(22) Filed: Jan. 2, 2001

(30) Foreign Application Priority Data
Oct. 30, 2000 (TW) 089218820

(51) Int. Cl. B62M 1/00; B62K 15/00

(52) U.S. Cl. 280/87.041; 280/655.1; 280/87.05

(57) ABSTRACT

A handlebar unit and footplate mounting arrangement includes a handlebar unit having a head tube, a sector-like mounting frame fixedly provided at the front side of a footplate, a connecting bar having a front end fixedly secured to the head tube and a rear end pivoted to the mounting frame, a quick-release lock adapted to lock the handlebar unit between the extended position and the collapsed position, the sector-like mounting frame having front peripheral locating notches for enabling the quick-release lock to lock the handlebar unit in the extended position and rear peripheral locating notches for enabling the quick-release lock to block the handlebar unit in the collapsed position.

### BACKGROUND OF THE INVENTION

The present invention relates to kick scooters and, more specifically, to a handlebar unit and footplate mounting arrangement for a kick scooter, which enabling the parts to be modularized and quickly assembled without welding.

FIG. 1 shows a conventional kick scooter. This structure of kick scooter comprises a handlebar unit A holding a front wheel, a footplate C, a connecting bar B obliquely connected between the head tube of the handlebar unit A and the front side of the footplate C by welding, and a rear wheel holder and fender assembly D welded to the rear side of the footplate C to hold a rear wheel. This structure of kick scooter has numerous drawbacks. Because the connecting bar B is obliquely fixedly connected between the handlebar unit A and the footplate C by welding and the rear wheel holder and fender assembly D is fastened to the rear side of the footplate C by welding, the kick scooter is not folding collapsible. The welding procedure is complicated and greatly increases the manufacturing cost of the kick scooter. During welding, a toxic gas is produced, which is harmful to the health of the workers. After welding, the welding areas E must be polished and washed with diluted sulfuric acid solution and clean water, and then treated with an electroplating process. The welding areas E are less strong, and tend to be damaged upon an impact.

### SUMMARY OF THE INVENTION

The present invention has been accomplished to provide a handlebar unit and footplate mounting arrangement for kick scooter, which eliminates the aforesaid drawbacks. It is one object of the present invention to provide a handlebar unit and footplate mounting arrangement for kick scooter, which greatly reduces the manufacturing cost of the kick scooter. It is another object of the present invention to provide a handlebar unit and footplate mounting arrangement for kick scooter, which eliminates the procedure of welding. It is still another object of the present invention to provide a handlebar unit and footplate mounting arrangement for kick scooter, which makes the kick scooter folding collapsible. To achieve these and other objects of the present invention, a handlebar unit and footplate mounting arrangement for kick scooter is provided comprised of a handlebar unit having a head tube, a sector-like mounting frame fixedly provided at the front side of a footplate, a connecting bar having a front end fixedly secured to the head tube and a rear end pivoted to the mounting frame, a quick-release lock adapted to lock the handlebar unit between the extended position and the collapsed position, the sector-like mounting frame having front peripheral locating notches for enabling the quick-release lock to lock the handlebar unit in the extended position and rear peripheral locating notches for enabling the quick-release lock to block the handlebar unit in the collapsed position. Further, spring means is provided to impart a downward pressure to the quick-release lock, keeping the quick-release lock secured to the front peripheral locating notches or rear peripheral locating notches of the mounting frame.

### BRIEF DESCRIPTION OF THE DRAWINGS

FIG. 1 is an elevational view of a kick scooter according to the prior art.

FIG. 2 is an exploded view of the present invention.

FIG. 3 is an assembly view of the present invention, showing the handlebar unit locked in the extended position.

FIG. 4 is an elevational view of a kick scooter constructed according to the present invention.

FIG. 5A illustrates the handlebar unit locked in the extended position according to the present invention.

FIG. 5B illustrates the handlebar unit locked in the collapsed position according to the present invention.

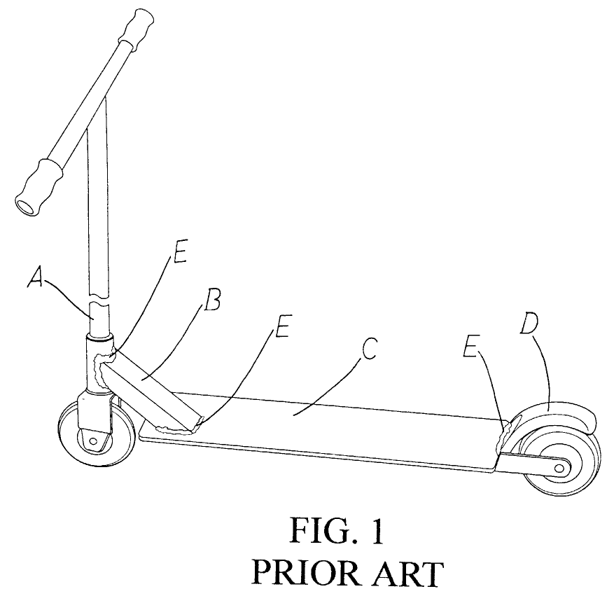

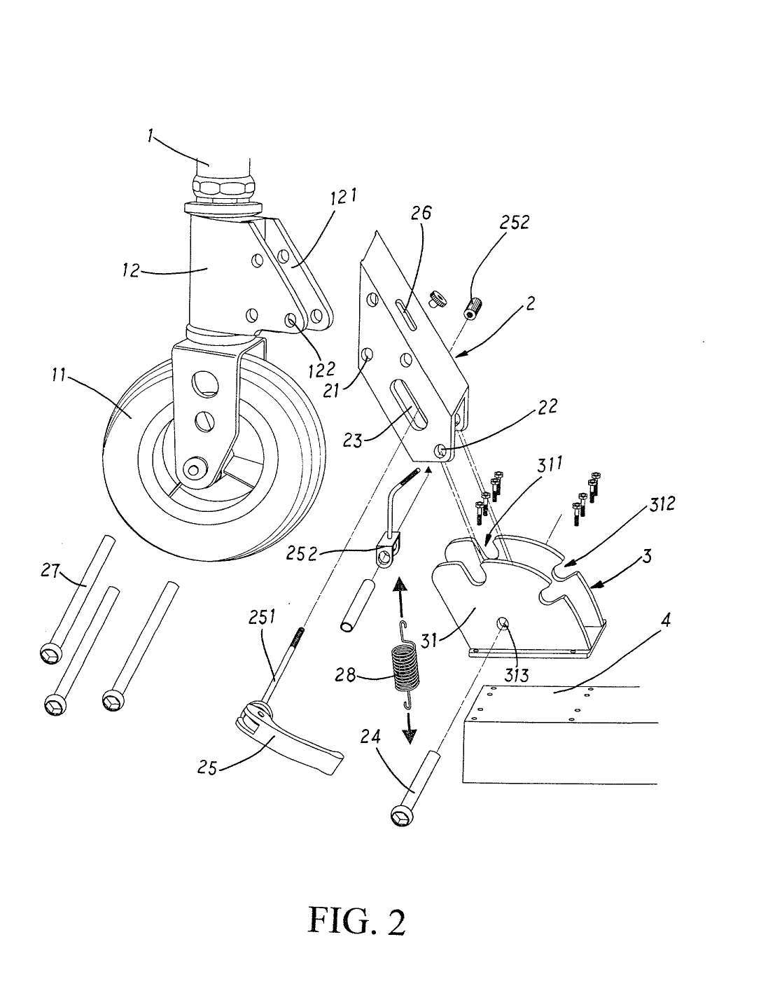

### DETAILED DESCRIPTION OF THE PREFERRED EMBODIMENT

Referring to FIGS. from 2 through 4, a handlebar unit and footplate mounting arrangement for a kick scooter in accordance with the present invention is comprised of a handlebar unit 1, a connecting bar 2, a mounting frame 3, and a footplate 4. The handlebar unit 1 holds a front wheel 11 at its bottom side. The footplate 4 holds a rear wheel 41 at its rear side. The handlebar unit 1 comprises a head tube 12. The head tube 12 comprises two parallel lugs 121, each of the lugs 121 having a plurality of mounting holes 122. The connecting bar 2 comprises a plurality of front mounting holes 21 symmetrically provided at two parallel side walls thereof at the front side, two rear pivot holes 22 respectively provided at the two parallel side walls at the rear side, two longitudinal sliding slots 23 symmetrically provided at the parallel side walls between the front mounting holes 21 and the rear pivot holes 22, and an elongated hole 26 provided at the top wall thereof. The mounting frame 3 is fixedly mounted on the footplate 4 at the front side, comprising two sector-like sidewalls 31 arranged in parallel. The sector-like sidewalls 31 each comprise a pivot hole 313, a front peripheral locating notch 311 and a rear peripheral locating notch 312. The front end of the connecting bar 2 is inserted in between the lugs 121 of the head tube 12, for enabling the front mounting holes 21 of the connecting bar 2 to be respectively connected to the mounting holes 121 of the lugs 121 of the head tube 12 of the handlebar unit 1 by respective bolts 27. The rear end of the connecting bar 2 is inserted in between the parallel sidewalls 21 of the mounting frame 2, for enabling the rear pivot holes 22 to be pivotally coupled to the pivot holes 313 of the parallel sidewalls 31 of the mounting frame 3 by a pivot 24.

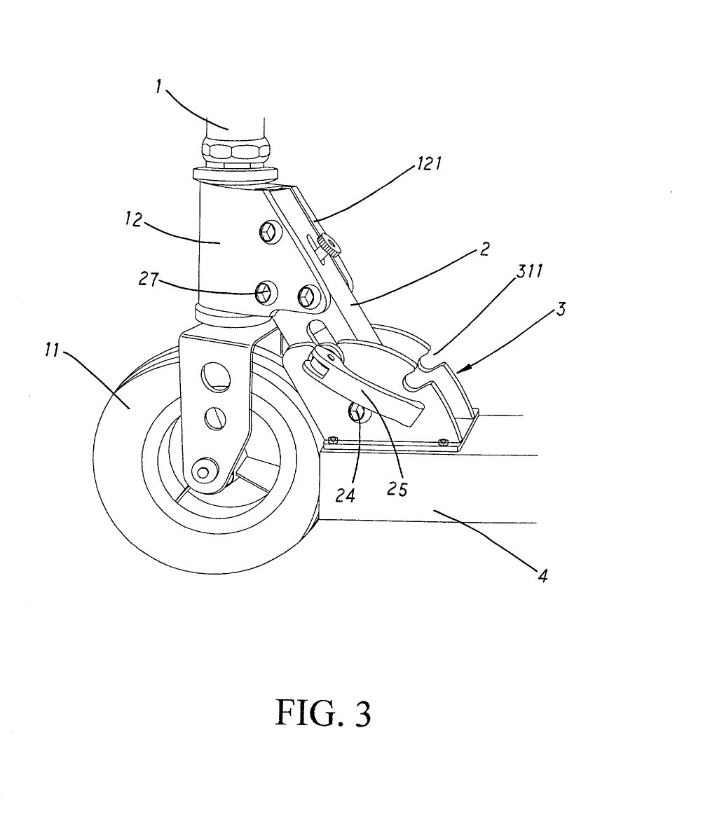

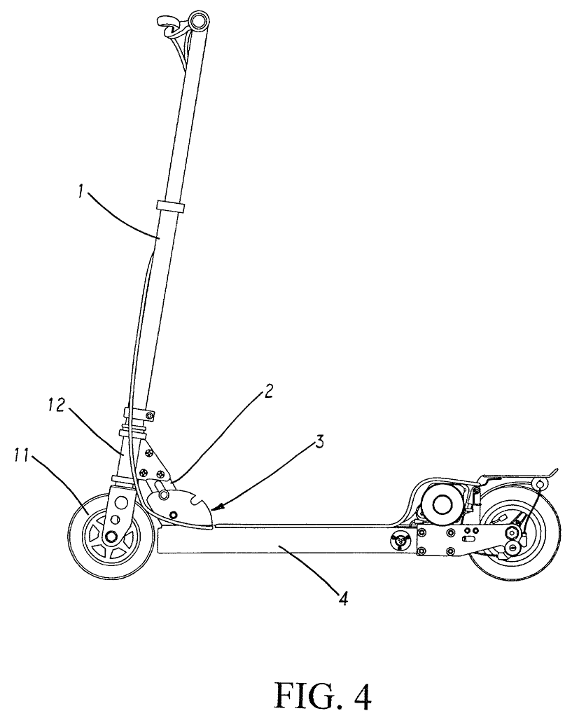

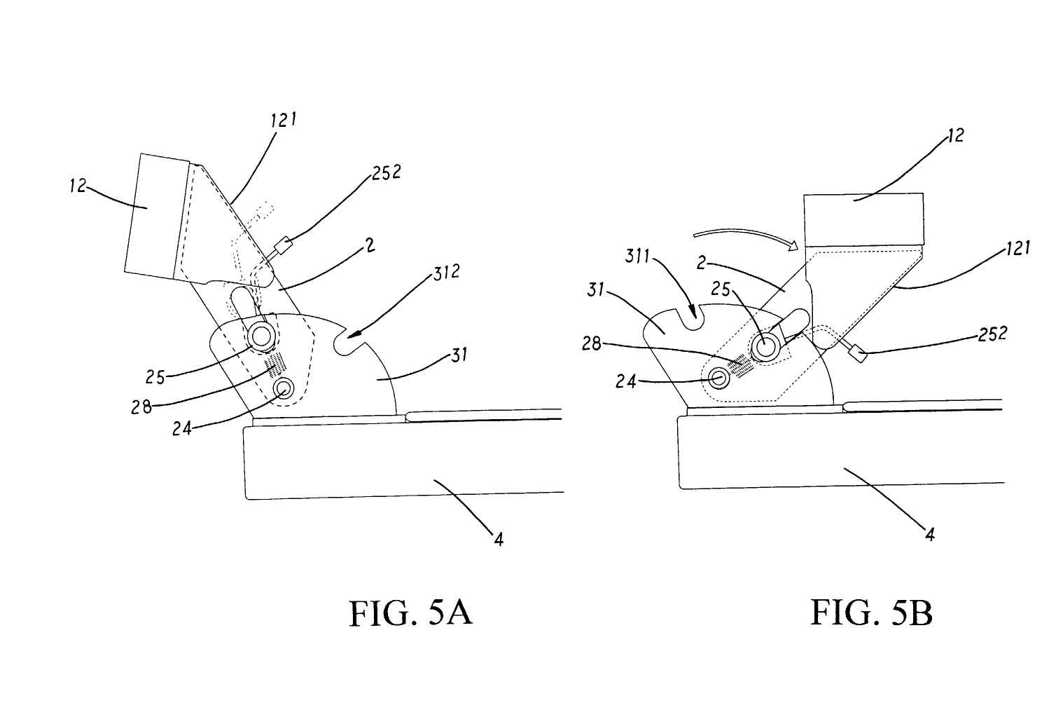

Referring to FIGS. 5A and 5B and FIGS. from 2 through 4 again, a quick-release lock is installed in the sliding slots 23 of the connecting bar 2 and adapted to lock the kick scooter between the extended (operative) position as shown in FIGS. 3 and 5A and the collapsed (non-operative) position as shown in FIG. 5B. The quick-release lock comprises an axle 251 inserted through the sliding slots 23 of the connecting bar 2, a screw nut 252 threaded onto one threaded end of the axle 251 and stopped at one side of the connecting bar 2, and a locking lever 25 pivoted to the other end of the axle 251 and disposed at the other side of the connecting bar 2. The locking lever 25 is turned between the locking position where the axle 251 is secured to the front peripheral locating notches 311 or rear peripheral locating notches 312 of the sidewalls 31 of the mounting frame 3, and the unlocking position where the axle 251 is released from the constraint and can be shifted between the front peripheral locating notches 311 and the rear peripheral locating notches 312 of the sidewalls 31 of the mounting frame 3. A tensile spring 28 is connected between the pivot 24 and the axle 251 to impart a downward pressure to the axle 251, causing the axle 251 to be secured to the front peripheral locating notches 311 or rear peripheral locating notches 312 of the sidewalls 31 of the mounting frame 3. Further, a pull handle 252 is coupled to the axle 251 and extended out of the elongated hole 26 of the connecting bar 2 for pulling by hand to overcome the spring force of the tensile spring 28 and to lift the axle 251 from the front peripheral locating notches 311 or rear peripheral locating notches 312 of the sidewalls 31 of the mounting frame 3, for enabling the kick scooter to be turned between the extended (operative) position and the collapsed (non-operative) position.

Referring to FIGS. 5A and 5B again, when pulling the pull handle 252 to disengage the axle 251 from the front peripheral locating notches 311 or rear peripheral locating notches 312 of the sidewalls 31 of the mounting frame 3 after the locking lever 25 had been turned to the unlocking position, the handlebar unit 1 can be turned with the connecting bar 2 relative to the mounting frame 3 and the footplate 4 to shift the axle 251 between the front peripheral locating notches 311 and the rear peripheral locating notches 312. After the axle 251 has been engaged into the front peripheral locating notches 311 or the rear peripheral locating notches 312, the locking lever 25 is turned from the unlocking position to the locking position to lock the kick scooter in the extended (operative) position.

The head tube 12, the connecting bar 2, and the mounting frame 3 according to the present preferred embodiment of the present invention are made of metal by die-casting. Because most parts of the kick scooter can be made through a mass production process, the manufacturing cost of the kick scooter is inexpensive. Further, because the invention eliminates the application of welding, the fabrication of the kick scooter is safe to the workers.

While only one embodiment of the present invention has been shown and described, it will be understood that various modifications and changes could be made thereunto without departing from the spirit and scope of the invention disclosed.

What the invention claimed is:

1. A handlebar unit and footplate mounting arrangement comprising a handlebar unit holding a front wheel, a footplate holding a rear wheel, a mounting frame fixedly mounted on said footplate at a front side, a connecting bar coupled between said handlebar unit and said mounting frame for enabling said handlebar unit to be turned relative to said mounting frame and said footplate between an extended position and a collapsed position, and a quick-release lock adapted to lock said handlebar unit between said extended position and said collapsed position, wherein:
said handlebar unit comprises a head tube, said head tube comprising two parallel lugs, said lugs each having a plurality of mounting holes;
said mounting frame comprises two sector-like sidewalls arranged in parallel, and a pivot connected between said sector-like sidewalls, said sector-like sidewalls each comprising a pivot hole, which receives said pivot, a front peripheral locating notch adapted to receive said quick-release lock for enabling said quick-release lock to lock said handlebar unit in said extended position, and a rear peripheral locating notch adapted to receive said quick-release lock for enabling said quick-release lock to lock said handlebar unit in said collapsed position;
said connecting bar comprises a plurality of front mounting holes symmetrically provided at two parallel side walls thereof at a front side and respectively fastened to the mounting holes of the lugs of said head tube by bolts, two rear pivot holes respectively provided at the two parallel side walls thereof at a rear side and pivotally connected to the pivot holes of the sector-like sidewalls of said mounting frame by a pivot, two longitudinal sliding slots symmetrically provided at the parallel side walls thereof between said front mounting holes and said rear pivot holes and adapted to receive said quick-release lock.

2. The handlebar unit and footplate mounting arrangement of claim 1, wherein said quick-release lock comprises an axle inserted through the sliding slots of said connecting bar and adapted to alternatively engage into the front peripheral locating notch and rear peripheral locating notch of said mounting frame, said axle having a first end and a second end, a screw nut fastened to the first end of said axle and stopped at one side of said connecting bar, and a locking lever pivoted to the second end of said axle and disposed at an opposite side of said connecting bar.

3. The handlebar unit and footplate mounting arrangement of claim 1 further comprising spring means connected between the pivot of said mounting frame and the axle of said quick-release lock and imparting a downward pressure to the axle of said quick-release lock.
